(19) United States
(12) Patent Application Publication
(10) Pub. No.: US 2015/0311721 A1
(43) Pub. Date: Oct. 29, 2015

(54) REMOTE ACCESS, CONTROL, AND MANAGEMENT OF A POWER MICRO GRID

(71) Applicant: NUEVO POWER, INC., Saratoga, CA (US)

(72) Inventors: Sanjay UPPAL, Los Altos Hills, CA (US); Somnath NAG, Saratoga, CA (US); Irfan Arshad MALIK, Santa Clara, CA (US)

(21) Appl. No.: 14/650,257

(22) PCT Filed: Dec. 9, 2013
(86) PCT No.: PCT/US13/73908

§ 371 Date: Jun. 5, 2015

Related U.S. Application Data
(60) Provisional application No. 61/734,960, filed on Dec. 7, 2012.

(51) Int. Cl. H02J 4/00; H01L 31/04; G05B 15/02

(52) U.S. Cl. CPC H02J 4/00; G05B 15/02; H02S 10/00

(57) ABSTRACT

Systems, methods, and apparatuses are disclosed for remote access, and management of a power grid and their associated loads. At least certain embodiments are configured for provisioning and control of decentralized non-grid connected power sources and corresponding power loads, including DC from photovoltaics (“PVs”) and AC from inverters, to a variety of power loads such as various electrical motors, lights as well as residential or business appliances. Aspects of the techniques described herein further include automated monitoring of various sensors including sensors that measure power, voltage, current, temperature, and humidity of the power sources as well as notification triggers and alarms to a feature phone. Other aspects are further adapted to track and receive payment for electric power from consumers connected with the decentralized non-grid power sources. The control of the power sources and loads can be bi-directional and can be performed using a smartphone that interfaces with a microcontroller.

### REFERENCE TO CROSS-RELATED APPLICATION

This application claims priority to Provisional Application Ser. No. 61/734,960 filed on Dec. 7, 2012.

### FIELD OF THE ART

Described is a micro grid power management system and method of using the same, and specifically to remote access and management of electrical micro grids and their associated loads.

### SUMMARY

Systems, methods, and apparatuses are disclosed for remote access, control and management of a power grid from and to mobile devices. At least certain embodiments are configured for provisioning and control of decentralized non-grid connected power sources and corresponding power loads, including DC from photovoltaics (“PVs”) and battery systems, and AC from inverters, to a variety of power loads such as various electrical motors, electrical pumps, lights as well as residential or business appliances.

Aspects of the techniques described herein further include automated monitoring of various sensors including sensors that measure power, voltage, current, of the power sources and temperature, and humidity of the environment as well as notification triggers and alarms to a mobile phone.

Other aspects are further adapted to track and receive payment for electric power from consumers connected with the decentralized non-grid power sources. The control of the power sources and loads can be bi-directional and can be performed using a smartphone that interfaces with a microcontroller.

In one particular embodiment, the smartphone can house the software control intelligence for the system. Advantageously, each connected load can become a member in the Internet of Things (“IoT”) and can be tracked via the Internet from anywhere in the world.

### BRIEF DESCRIPTION OF THE DRAWINGS

These and other aspects and features will become apparent to those ordinarily skilled in the art upon review of the following description of specific embodiments of the invention in conjunction with the accompanying figures, in which:

FIG. 1 depicts an example system for remote access, control and management of a power grid according to one embodiment.

FIG. 2 depicts an example system for remote access, control and management of a power grid according to an alternate embodiment.

FIG. 3 depicts exemplary components of a system for remote access and management of a power grid according to one embodiment.

### DETAILED DESCRIPTION

Throughout the description, for the purposes of explanation, numerous specific details are set forth in order to provide a thorough understanding. It will be apparent; however, to one skilled in the art that the embodiments described herein may be practiced without some of these specific details. In other instances, well-known structures and devices are shown in block diagram form to avoid obscuring the underlying principles of the various embodiments.

A system, methods, and apparatuses are disclosed for remote access, control and management of a power grid. At least certain embodiments are configured for provisioning and control of decentralized non-grid connected power sources and corresponding power loads, including DC from photovoltaics (“PVs”), and battery systems, and AC from inverters, to a variety of power loads such as various electrical motors, electrical pumps, lights as well as residential or business appliances. Aspects of the techniques described herein further include automated monitoring of various sensors including sensors that measure power, voltage, current, of the power sources and temperature, and humidity of the environment as well as notification triggers and alarms to a mobile phone. Aspects further adapted to track and receive payment for electric power from consumers connected with the decentralized non-grid power sources. The control of the power sources and loads can be bi-directional and can be performed using a smartphone that interfaces with a microcontroller. In one embodiment, the microcontroller can be a SoLX ImPACT appliance and the smartphone can be an Android-based smartphone. An ImPACT appliance can provide: (1) automated monitoring and notification; (2) bi-directional control of power line communications (“PLC”) via a microcontroller to Android interface; (3) load discovery and power allocation on the PLC; and (4) pre-paid funds for retail power distribution. In one embodiment the microcontroller can be an Arduino board.

In one embodiment, an intelligent protocol over PLC can be utilized for each load to obtain its characteristics with respect to each other load as well as to obtain characteristics of each different power source. As is well known in the art, PLC is configured to carry data on an electrical conductor line that is also used simultaneously for AC power transmission or distribution to consumers. The power sources themselves can be used to intelligently allocate power to each load according to its characteristics and to dynamically adapt the power transmitted to each load of a running system.

Embodiments further provide a payment mechanism adapted to work with a smartphone to enable retail purchase of power via one or more of the following: (1) purchasing power credits at a retail location or over the air using value stored on a card associated with a user; (2) transferring of power credits to the microcontroller over the air; (3) automated checking of the power credit balance of a user's account via the microcontroller; (4) decrementing power credits as power is consumed; and (5) incrementing power credits for user complaints such as lost or poor power. Other embodiments are adapted to recognize and prevent power from being stolen from the system.

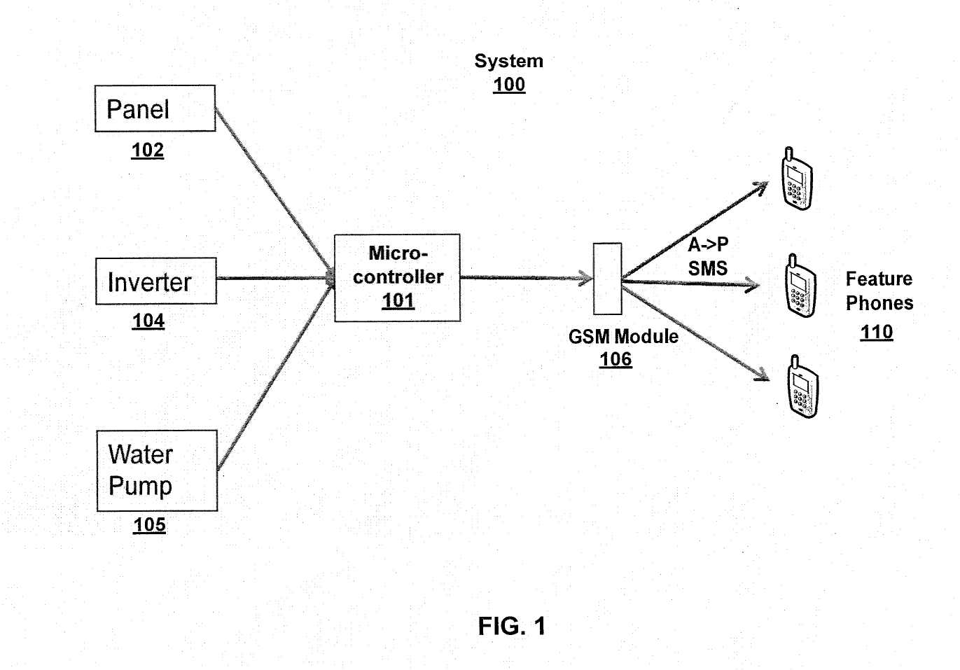

The method of operation of the microcontroller includes that power is generated by a variety of sources including PV panels. FIG. 1 depicts an example system for remote access and management of a power grid according to one embodiment. In the illustrated embodiment, microgrid 100 includes a solar panel 102, inverter 104, water pump 105, and microcontroller 101, as well as feature phones 110 coupled with an interface module 106. Power can be fed to an inverter 104 that is custom built for the type of loads that the sources will encounter. The inverter 104 includes a built-in conditioner that can also provide DC-DC conversion, Both AC and DC sources are then fed to the microcontroller from one or more of panel 102, inverter 104, and water pump 105. In at least certain embodiments, the microcontroller is adapted to include a bi-directional control channel via the PLC from the power source to its corresponding loads. The lower layer of the control can be carried out by readily available PLC components. There is a controller PLC in microcontroller 101 and the controlled PLC in each load. The microcontroller 101 is configured to add intelligence on top of the PLC layer by sending and receiving control information that can be acted upon based on policies that have been set by power source operators. The power can then be transmitted from the source to the load. This power can be represented as a function of temperature, humidity, current, load, power factor, price, fund availability in the mobile wallet, and or credit worthiness factors where each variable is also a function of time. This general control mechanism is dependent on environmental factors, load factors, pricing of power, as well as the ability of the customer to pay.

Once the microcontroller has ascertained the amount of power to be sent to each load, then the controlled PLC acts upon a command from the microcontroller and can start, stop, ramp up or down, or actuate or de-actuate the sensors at the load. As power is being fed from the source to the load, the microcontroller 101 keeps track of the power consumed by each load and compares it to the power sent by the source. If the power consumed is more than that sent from the source, then there is leakage and a warning is sent, followed by disconnection. The microcontroller can also compare the price of the power consumed by each load compared to the available funds for the consumer who has ownership of that load. If the consumer has exhausted their funds, then the credit worthiness of that consumer can be used to determine whether to cut off power instantly or a ramp it down. The consumer can add to their funds by purchasing additional power credits from a retail location. In addition, the interface module 106 can be used to provide A2P SMS communications using a GSM network, or other methods of communications such as Ethernet and Wi-Fi with correspondingly different messages based upon the chosen format to feature phones 110 of the consumers. A2P (application-to-person) SMS is a process in which an SMS text message is produced from an application (such as an advertising message) and is sent to a mobile subscriber. Typical use cases include general alerting and update messages such as banking updates, flight alerts, check-in and boarding passes, mobile ads, and mobile event ticketing. Many countries have a large penetration of feature phones with free incoming SMS. Thus, customer and system support personnel can get real-time cumulative alerts and alarms for power monitoring activities.

In one embodiment, the microcontroller includes an Arduino platform. Arduino is an open-source, single-board microcontroller designed to make the process of using electronics in multidisciplinary projects more accessible. The hardware consists of a simple open hardware design for the Arduino board with an Atmel AVR processor and on-board input/output support. The software consists of a standard programming language compiler and the boot loader that runs on the board. Arduino hardware is programmed using a wiring-based language (syntax and libraries), similar to C++ with some slight simplifications and modifications, and a processing-based integrated development environment. Current versions can be purchased pre-assembled. Hardware design information is available for those who would like to assemble an Arduino by hand. The Arduino Platform forms a core for fault and performance monitoring of the solar and electrical characteristics of the system.

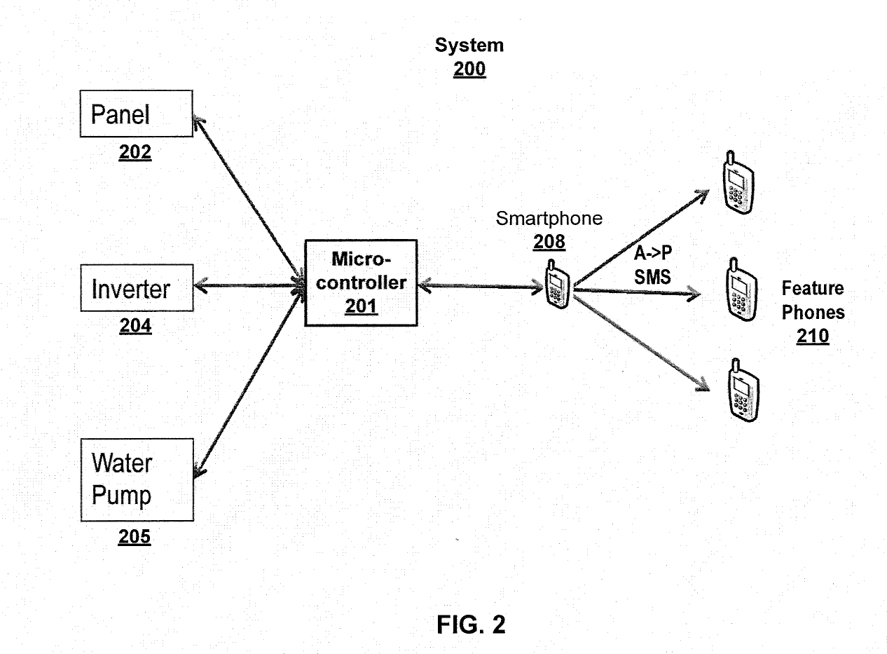

FIG. 2 depicts an example system for remote access and management of a power grid according to an alternate embodiment. The illustrated embodiment of microgrid 200 is substantially the same as microgrid 100 except that a smartphone 208 is used to provide the GSM A2P SMS or other messages (such as Ethernet or Wi-Fi) to the feature phones 210 of the consumers instead of using interface module 106. In one embodiment, the smartphone 208 can be an Android-based smartphone. An Accessory Development Kit (“ADK”) can be used to match the Arduino Platform with the Android phones for sensor control and monitoring such that the system can effectively be controlled remotely from a suitable smartphone. The platform is further extensible to sensing a wide range of environmental conditions and can effectively make each controlled load become a member of the Internet of Things (“IoT”). The IoT refers to uniquely identifiable objects (things) and their virtual representations in a computer-based or Internet-like structure.

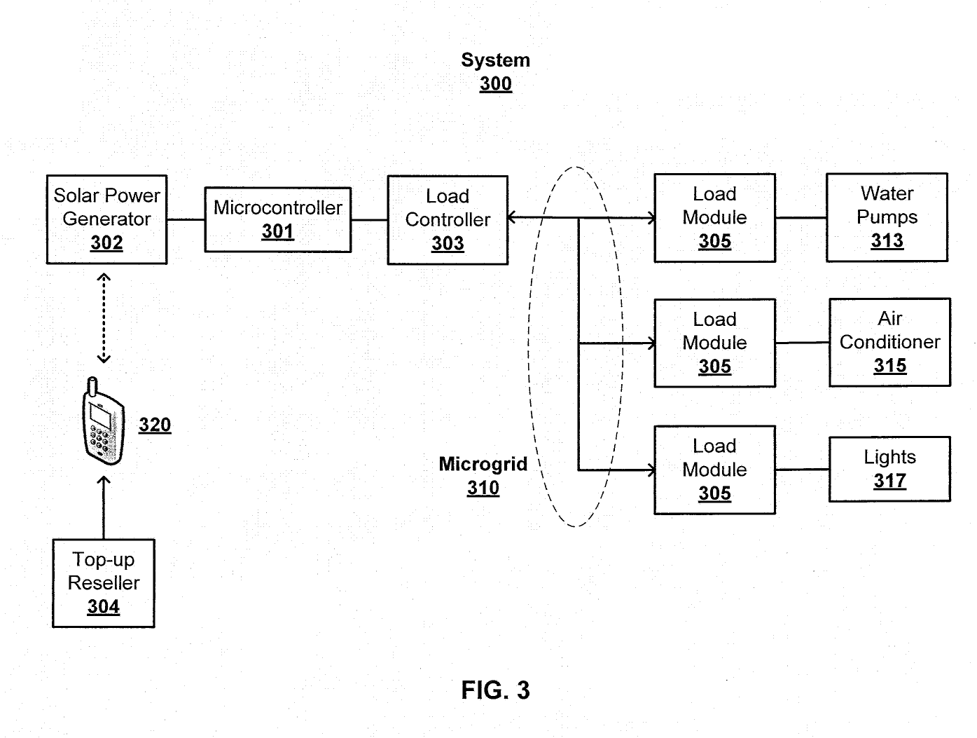

FIG. 3 depicts exemplary components of a system for remote access and management of a power grid according to one embodiment. The illustrated embodiment of system 300 is configured to control load elements 313-317 via load modules 305 connected with a private grid referred to herein as microgrid 310. Consumers 320 of the non-grid (or private grid) power sources can purchase power credits from resellers to top-off the funds associated with their power account. In one embodiment, a “mobile wallet” can be used for this functionality. Solar power generator 302 can then verify the consumer's balance and cause controller 303 to be programmed via microcontroller 301. Load controller 303 can be configured to check for available balance of funds and to communicate to the load modules 305, which are adapted to turn on/off to devices connected to the microgrid 310 when so directed by the load controller 303. Further, load controller 303 can be configured to shut off power off whenever it loses communication with the load module 305, e.g., when someone cuts the line at the load to steal power. In the illustrated embodiment, the loads connected to microgrid 310 include water pumps 313, air conditioner units 315, and lights 317. Other load elements are contemplated.

Although particularly described herein with reference to the preferred embodiments thereof, it should be readily apparent to those of ordinary skill in the art that changes and modifications in the form and details may be made without departing from the intended spirit and scope. Further, embodiments may include various operations as set forth above, or fewer or more operations, or operations in an order different from the order described. Also an embodiment showing a singular component should not be considered limiting; rather, embodiments are intended to encompass other embodiments including a plurality of the components, and vice-versa, unless explicitly stated otherwise.

In addition, the techniques described herein are not limited to any specific combination of hardware circuitry or software. It will be apparent to skilled artisans from this description that aspects may be embodied in software, hardware, firmware, or a combination of these. For instance, in various embodiments, hardwired circuitry may be used in combination with software instructions. Operations may be embodied in computer-executable instructions which cause a general-purpose or special-purpose processor to perform the disclosed operations. In other embodiments, they can be implemented with custom hardware alone. Operations may be performed by specific hardware components that contain hardwired logic configured to perform those same operations.

What is claimed is:

1. A system for controlling an off-grid power supply network, the off-grid power supply network including a plurality of power sources, the plurality of power sources including a plurality of solar panels and a plurality of loads, wherein certain ones of the plurality of loads are connected through an inverter circuit, the system comprising:
a microcontroller, the microcontroller enabling bi-directional communications that include:
automated source discovery, monitoring and notification with respect to each of the plurality of sources using power line communications;
automated load discovery, monitoring, notification and power allocation with respect to each of the plurality of loads using power line communications; and
provisioning for retail power distribution based upon pre-paid funds using a communications network; and
an interface coupled to the microcontroller that that allows for communications using the communications network.

2. The system of claim 1 wherein the microcontroller further includes translation of power line communication commands into communication network commands.

3. The system of claim 2, wherein the provisioning for retail power distribution is implemented using a software layer disposed on top of the power line communications, and wherein the software layer disposed on top of the power line communications provides commands intelligible by the communications network.

4. The system of claim 2 wherein the interface is an Android smartphone.

5. The system of claim 2 wherein the interface is a GSM module.

6. The system of claim 2 wherein the interface is an Ethernet module.

7. The system of claim 2 wherein the interface is a Wi-Fi module.

8. The system of claim 2 wherein the provisioning for retail power distribution includes:
receipt at the microcontroller of power credits associated with a particular load;
automated checking of a power credit balance associated with the particular load; and
automatically decrementing power credits associated with the particular load as power is consumed at the particular load.

9. The system of claim 8, wherein the provisioning for retail power distribution is implemented using a software layer disposed on top of the power line communications.

10. The system of claim 8 wherein the step of automatically decrementing power credits associated with the particular load as power is consumed at the particular load further includes:
determining if all credits have been used; and
based upon a creditworthiness determination, automatically determining whether to instantly turn power off to the particular load or turn power off to the particular load over a period.

11. The system of claim 1 wherein the automated source discovery, monitoring and notification with respect to each of the plurality of sources using power line communications obtains characteristics of each source, and wherein the automated load discovery, monitoring, notification and power allocation with respect to each of the plurality of loads using power line communications obtains characteristics of each load.

12. A method for controlling an off-grid power supply network, the off-grid power supply network including a plurality of power sources, the plurality of power sources including a plurality of solar panels and a plurality of loads, wherein certain ones of the plurality of loads are connected through an inverter circuit, the method comprising:
enabling bi-directional communications on the off-grid power supply network, the bi-directional communications enabled by a microcontroller, and including:
automated source discovery, monitoring and notification with respect to each of the plurality of sources using power line communications;
automated load discovery, monitoring, notification and power allocation with respect to each of the plurality of loads using power line communications; and
provisioning for retail power distribution based upon pre-paid funds using a communications network; and
enabling communications using a communications network using an interface, wherein the interface is coupled to the microcontroller.

13. The method of claim 12 further including translation of power line communication commands into communication network commands by the microcontroller.

14. The method of claim 13, wherein the provisioning for retail power distribution is implemented using a software layer disposed on top of the power line communications, and wherein the software layer disposed on top of the power line communications provides commands intelligible by the communications network.

15. The method of claim 12 wherein the provisioning for retail power distribution includes:
receipt at the microcontroller of power credits associated with a particular load;
automated checking of a power credit balance associated with the particular load; and
automatically decrementing power credits associated with the particular load as power is consumed at the particular load.

16. The method of claim 15, wherein the provisioning for retail power distribution is implemented using a software layer disposed on top of the power line communications.

17. The method of claim 15 wherein the step of automatically decrementing power credits associated with the particular load as power is consumed at the particular load further includes the steps of:
determining if all credits have been used; and
based upon a creditworthiness determination, automatically determining whether to instantly turn power off to the particular load or turn power off to the particular load over a period.

18. The system of claim 12 wherein the automated source discovery, monitoring and notification with respect to each of the plurality of sources using power line communications obtains characteristics of each source, and wherein the automated load discovery, monitoring, notification and power allocation with respect to each of the plurality of loads using power line communications obtains characteristics of each load.
